(19) United States
(12) Patent Application Publication
(10) Pub. No.: US 2012/0227716 A1
(43) Pub. Date: Sep. 13, 2012

(54) TWO-STROKE MOTOR WITH IMPROVED SILENCER AND ADAPTED MOTOR MANAGEMENT

(75) Inventor: Michael SCHOENFELD, Rohlstorf (DE)

(73) Assignee: MAKITA CORPORATION, Anjo-shi (JP)

(21) Appl. No.: 13/372,968

(22) Filed: Feb. 14, 2012

(30) Foreign Application Priority Data
Mar. 9, 2011 (DE) 20 2011 000 525.9

(51) Int. Cl. F01N 3/00; F02B 5/00

(52) U.S. Cl. 123/65 PE

(57) ABSTRACT

In order to further develop a two-stroke motor with a silencer, whereby the silencer has a silencer inlet to which a flow channel connects, and the flow channel is so flow-beneficially designed between the silencer inlet and the first chamber that due to its mass inertia the exhaust gas flowing into the silencer inlet predominantly flows into the first chamber and after filling the first chamber flows back again thereby forming a counter-pressure in the direction of the combustion chamber, so that the above-described drawbacks are prevented, it is proposed to set the ignition time for igniting a fuel-air mixture present in the combustion chamber at an earlier time before the dead centre of a piston defining the combustion chamber in terms of stroke movement, compared with the ignition time of a two-stroke motor operated with a silencer structurally limited to the second chamber.

The present invention relates to a two-stroke motor, more particularly for a hand operated power tool such as a gardening or park-tending device or for a moped, a boat motor or suchlike, with a silencer, whereby the silencer has a silencer inlet to which a flow channel is connected so that the flow channel can be attached by means of the silencer inlet at outlet of the combustion chamber of the two-stroke motor, whereby at the channel end opposite the silencer inlet the flow channel opens out into a first chamber, whereby a second chamber is provided into which the exhaust gas flows through a main outlet branching from the flow channel, whereby the first chamber is preferably surrounded by the second chamber and whereby the flow channel between the silencer inlet and the first chamber is designed to benefit the flow in such a way that due to its mass inertia, the exhaust gas flowing into the silencer mainly flows into the first chamber and after filling the first chamber flows back again and thereby brings about a counter-pressure in the direction towards the combustion chamber, in accordance with the introductory section of claim 1.

### PRIOR ART

DE 20 2008 005 168 U1 sets out a type-defining two-stroke motor with a silencer of the design of interest here. The two-stroke motor is shown in simplified form and the silencer is arranged on the outlet of the two-stroke motor so that the fuel-air mixture ignited in the combustion chamber of the two-stroke motor can enter the silencer. In doing so the exhaust gas enters a flow channel of the silencer via which the silencer is attached to the cylinder of the two-stroke motor by way of the silencer inlet. Connected to the silencer inlet is a flow channel which via one channel end opens out into the first chamber. Between the silencer inlet and the end of the channel a main outlet is arranged on the flow channel and from the flow chamber, via the main outlet exhaust gas can enter into a second chamber which is larger than the first chamber and surrounds the first chamber.

The flow channel is straight so that exhaust gas entering the flow channel via the silencer initially predominantly flows into the first chamber and produces an excess pressure in the first chamber. Due to this excess pressure a large part of the exhaust gas flows back towards the silencer and forms a gas barrier which prevents the fuel-air mixture subsequently supplied to the combustion reaching the silencer without combustion. The geometric design of the flow channel and the first chamber with the relevant volume is determined so that a flow pattern of the exhaust gas in the flow channel and in the first chamber is created which corresponds with the stroke movement of the piston and the opening of the outlet of the combustion chamber when the piston moves towards the lower dead centre, and the upper end of the piston releases the outlet. This results in better emission values and, more particularly, the efficiency of the two-stroke motor can be improved through reduction in the ejection of unburned fuel compared with conventional silencers.

However, when operating the two-stroke motor with a silencer of the above type, it has been shown that the two-stroke motor can exhibit an increased level of knocking. The increased knocking level is explained by the increased proportion of residual gas in the combustion chamber of the cylinder and the resulting slower combustion rate of the fuel-gas mixture. The increase in the proportion of residual gas can be caused by the exhaust gas flowing back from the first chamber towards the silencer inlet and partially into the combustion chamber. If the piston moves from the lower dead centre back towards the top dead centre in order to compress the fuel-air mixture, an increased proportion of exhaust gas can remain in the combustion chamber as a component of the gas mixture and also become compressed. This results in delayed combustion, which can start too late. Through the reduced flushing of the combustion chamber the temperature of the cylinder may increase, which is also undesirable.

### DISCLOSURE OF THE INVENTION

It is therefore the objective of the present invention to further develop a two-stroke motor with a silencer of the type specified in the introductory section of claim 1. in such a way that the above-described drawbacks are prevented, more particularly the operating parameters of the motor are adapted to the operating parameters occurring during the operation of a two-stroke motor with a silencer which is structurally restricted to the second chamber, so that the flow channel opens directly via a channel opening into the second chamber.

This objective is achieved on the basis of a two-stroke motor in accordance with the introductory section of claim 1 in conjunction with the characterising features. Advantageous further development of the invention are set out in the dependent claims.

The invention includes the teaching that, compared with the ignition time of a two-stroke motor operated with a silencer limited to the second chamber, the ignition time for igniting a fuel-air mixture present in the combustion chamber is set at earlier time before the top dead centre of a piston defining the combustion chamber in terms of stroke movement.

In order to overcome the above disadvantages during the operation of a two-stroke motor with a silencer of the previously designated type, more particularly to counter the increased knocking level and rise in temperature, it has surprisingly been shown that by moving the ignition time forward the knocking level and temperature level can be returned to values known from the operation of the two-stroke motor with a silencer limited in its design to the second chamber, so that the flow channel opens directly into the second chamber.

A silencer of the simplified type, which is structurally restricted to the second chamber is shown as the prior art in FIG. 1. The two-stroke motor is designed in a known way with a cylinder 18, in which there is a combustion chamber 13 moveably defined by a piston 21. To form a crank assembly the piston 21 is connected via a connecting rod 23 to a crank shaft 22. The combustion chamber 13 has an outlet which is brought into connection with a silencer inlet 11. Connecting to the silencer inlet 11 is a flow channel 12 which opens into a channel opening 12′. The exhaust gas flowing via silencer inlet 11 into the flow channel 12 enters, via the channel opening 12′, the second chamber 16, which may be filled with an insulating material for example. The exhaust gas can then exit the second chamber 16 via outlet 19.

Although the shown silencer has properties for sound insulating the two-stroke motor, there is no first chamber into which the exhaust gas flowing through the flow channel initially enters, and after an increase in pressure in the first chamber flows back in the direction of the silencer inlet.

Two-stroke motors can be fitted with electric motor management, which, more particularly, determines the ignition time for igniting the fuel-air via a spark plug. It is known that advantageous operating parameters of the two-stroke motor set in if the fuel-air mixture is ignited via the spark plug at a crank angle of round 24° before the top dead centre during the upward movement of the piston.

If, in accordance with the invention, the ignition time is advanced so that the ignition time is set at a crank angle of the piston that is more than 24° before the top dead centre, it could surprisingly be determined that the above drawbacks of the increased knocking level and temperature level in the cylinder of the two-stroke motor are overcome and could be reduced back to normal levels as known for the operation of two-stroke motors operated with conventional silencers.

It has been found to be particularly advantageous for the ignition time to be set earlier before the top dead centre in such a way that knock-free operation of the two-stroke motor comes about or a knocking level during operation of the two-stroke motor sets in which is equivalent to the knocking level during the operation of the two-stroke motor with a silencer limited to the second chamber.

As a further advantage, the ignition time can be set earlier before the top dead centre in such a way that during the operation of the two-stroke motor a temperature level in the cylinder of the two-stroke motor sets in which corresponds with the temperature level during operation of the two-stroke motor with a silence limited to the second chamber. Also advantageous is an ignition time set earlier before the top dead centre so that during operation of the two-stroke motor an increase in pressure/° crank angle occurs in the combustion chamber of the cylinder of the two-stroke motor which corresponds with the increase in pressure/° crank angle during operation of the two-stroke motor with a silencer limited to the second chamber.

The knocking level, the temperature level as well as the increase in pressure/° crank angle are experience values which are known for two-stroke motors when operating with conventional silencers in accordance with the previously described prior art. Consequently the advancing of the ignition time to a value which is at least greater than 24° before the top dead centre of the piston in the upward movement can take place so that the temperature level and/or the increase in pressure/° crank angle reach values which correspond to the values which set in when the two-stroke motor is operated with a conventional silencer which is limited in its design to the second chamber.

It has been found to be particularly advantageous if the advance in the ignition time corresponds to a crank angle of at least 2°, preferably at least 4° and particularly preferably at least 6°. In this way the ignition time can for example be advanced to a crank angle of at least 26°, preferably at least 28° and particularly preferably at least 30° before the top dead centre of the piston. Values of greater than 30° before the top dead centre of the piston can also be set, which may depend on the detailed geometric design of the silencer with the first and the second chamber as well as the other operating parameters of the two-stroke motor.

To operate the two-stroke motor a spark plug for igniting the fuel-air mixtures is provided, which is operated with an ignition device, whereby the ignition device can have means through which the ignition time can be advanced. In terms of the two-stroke motor the ignition device and accompanying means are considered as an part of the two-stroke motor, and frequently ignition devices for motor management for the operation of the two-stroke motor are even integrated into the two-stroke motor or at least applied to the two-stroke motor. The means with which the ignition time can be advance can be designed as component of the motor management program so that corresponding means are used if the two-stroke motor is operated with a silencer of the above type with a first and a second chamber. In addition, the means can be manually adjustable means with which the ignition time is set during assembly and arranging the two-stroke motor for use, more particularly in a power tool. The setting can be undertaken in a one-off manner by way, for example, of software programming in the ignition device, through the use of an electronic module such as an EPROM or through other hardware means. The ignition time can of course also be set during assembly of the two-stroke motor by a fitter with the ignition device or even manually by a user when operating the power tool.

A rotation angle sensor can be advantageously provided, which is designed for determining the rotation angle and/or the speed of the crank shaft whereby the rotation angle sensor can be connected to the ignition device and designed for transmitting rotation angle and/or speed information to the ignition device. This provides the ignition device with information about the current stroke position of the piston in the cylinder so that via the rotation angle information the fuel-air mixture can be ignited by the spark plug in the required angle range during the upward movement of the piston. More particularly the rotation angle sensor can be designed so that the rotation angle sensor sends a signal to the ignition device when a rotation angle of the crank shaft before the top dead centre of the piston with a value or more than 24°, for example a value of 30°, is detected.

More particularly the rotation angle sensor can be integrated in the ignition device. Thus, the relevant crank angle is not detected directly but from the time required per revolution and the crank angle calculated from the time elapsing after passing a threshold trigger can be used so that in this way the ignition time can be advanced to the required value.

A knocking sensor can also be provided and connected to the ignition device, where the knocking sensor is designed for determining the knocking level and is preferably arranged on the cylinder. In this way a control circuit can be formed and the knocking sensor senses the knocking level on the cylinder of the two-stroke motor, and the ignition time determined by the ignition device dynamically depends on the knocking level sensed by the knocking sensor.

Such a control circuit can also be formed with a temperature sensor so that a temperature level sensor is envisaged and connected to the ignition device, whereby the temperature sensor is designed for determining the temperature of the cylinder and is preferably arranged on the cylinder. If he cylinder temperature reaches a level that is higher than the temperature level known when the two-stroke motor is operated with a conventional silencer, the ignition time can be advanced by the ignition device in such a way that the temperature level again corresponds with the usual temperature level. Consequently an active control circuit can be formed by way of a knocking sensor or alternatively also by way of the temperature sensor with the ignition device, and the parameter supplied by the knocking sensor and/or by the temperature can serve as the guide parameter for advancing the ignition time to an optimum value.

The objective of the present invention is also achieved by way of a power tool with a two-stroke motor with above-described features.

The objective of the present invention is also achieved through a method of operating a two-stroke motor, more particularly for a hand-operated power tool such as a gardening or park-tending tool or for a moped, a boat motor and suchlike, whereby the two-stroke motor is designed with a silencer and whereby the silencer has a silencer inlet to which a flow channel connects, so that the flow channel is attached by means of the silencer inlet to an outlet of the combustion chamber of the two-stroke motor, whereby the flow channel opens into a first chamber at the channel end opposite the silencer inlet, whereby a second chamber is also provided in which the exhaust gas flow through a main outlet branched off from the flow channel, whereby the first chamber is surrounded by the second chamber. The flow channel can be flow-beneficially designed between the silencer inlet and the first chamber so that due to its mass inertia the exhaust gas flowing into the silencer inlet predominantly flows into the first chamber, and after filling the first chamber flows back again so that a counter-pressure is formed in the direction of the combustion chamber. In accordance with the invention the ignition time for igniting a fuel-air mixture present in the combustion chamber can be set at an earlier time before the dead centre of a piston defining the combustion chamber in terms of stroke movement, compared with the ignition time of a two-stroke motor operated with a silencer structurally limited to the second chamber.

### BRIEF DESCRIPTION OF THE DRAWINGS

Further measures for improving the invention are set out below together with a preferred example of embodiment of the invention with the aid of the figures.

FIG. 1 shows a two-stroke motor with a silencer, which is designed as a single chamber silencer and corresponds with a silencer in accordance with a conventional design,

FIG. 2 shows an example of embodiment of a two-stroke motor with a silencer of the type of interest here, whereby the two-stroke motor can be operated with an ignition time advanced in accordance with the invention,

FIG. 3 shows a diagram with courses of the increase in pressure/° crank angle and

FIG. 4 shows a diagram with courses of the cylinder temperature over the speed of the two-stroke motor.

### PREFERRED EXAMPLE OF EMBODIMENT OF THE INVENTION

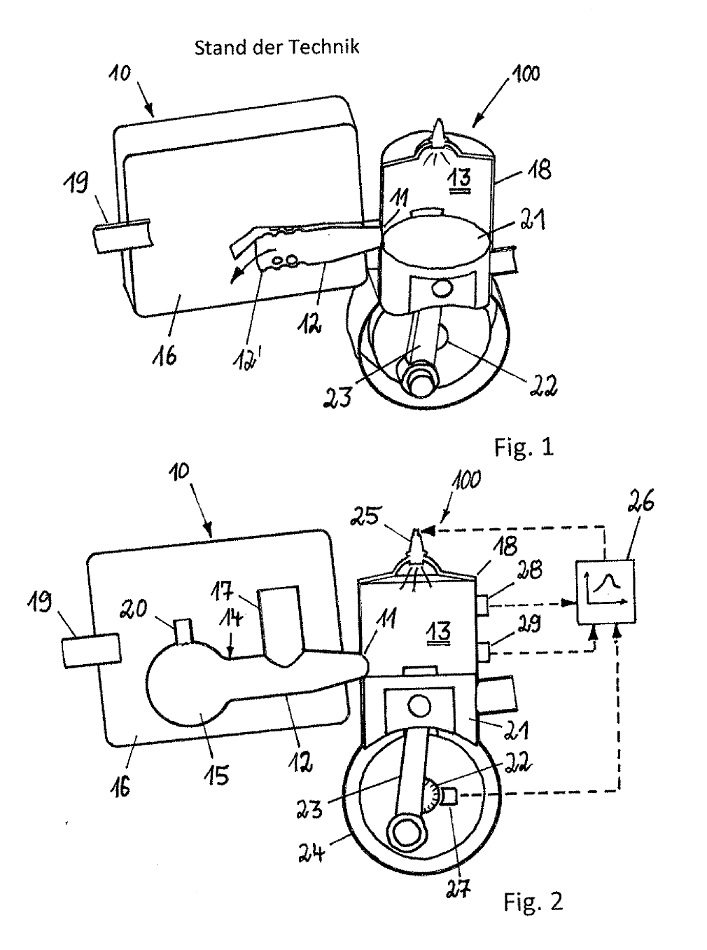

FIG. 1 has also been set out above and corresponds to a two-stroke motor 100 with a silencer 10, designed as single-chamber in accordance with a conventional design.

FIG. 2 shows a two-stroke motor 100, which is intended, for example, for a hand-operated power tool such as a gardening or park-tending tool or for a moped, a boat motor and suchlike. The two-stroke motor 100 is fitted with a silencer 10 which has a silencer inlet 11 to which a flow. channel 12 connects which is designed as a straight pipe. The flow channel 12 is attached with the silencer inlet 11 to an outlet of a combustion chamber 13 of the two-stroke motor 100, whereby the combustion chamber 13 of the two-stroke motor 100 is moveably defined by a piston 21. The piston 21 is connected via a connecting rod 23 to a crank shaft 22 of the two-stroke motor 100 which is borne in a rotating manner in a crank housing 24. The piston 21 is shown in the region of the lower dead centre, so that the silencer inlet 11 is open and the exhaust gas can flow through the silencer inlet 11 into the flow channel 12.

At the channel end 14 opposite the silencer inlet 11 the flow channel 12 opens out in to a first chamber 15, whereby a second chamber 16 is also provided, into which the exhaust gas flow through a main outlet 17 branched off from the flow channel 12. The first chamber 15 also has a secondary outlet 20 through which a further, smaller quantity of exhaust can enter directly from the first chamber 15 into the second chamber 16. The exhaust gas entering the second chamber 16 and leave the silencer 10 through an outlet 19 and be released.

The flow channel 12 between the silencer inlet 11 and the first chamber 15 is designed so flow-beneficially, that due to its mass inertia the exhaust gas flowing into the silencer inlet 11 predominantly flows into the first chamber 15, and after filling of the first chamber 15 flow back again forming a counter-pressure in the direction of the combustion chamber 13. This achieves the positive effect of preventing fuel-air mixture which flows into the combustion chamber 13 of the cylinder 18 of the two-stroke motor 100, being able to enter the silencer 10 through silencer inlet 11 without undergoing combustion. The exhaust gas flowing back from the first chamber 15 in the direction of the silencer inlet 11 forms a gas barrier which prevents uncombusted fuel-air mixture entering the silencer 10.

By way of the exhaust gas flowing towards the silencer inlet 11, part of the exhaust gas reaches the combustion chamber 13 so that the thermodynamic parameters for operating the two-stroke motor 100 exhibit slight changes. More particularly residual gas can return to the cylinder 18, resulting in a slower combustion rate. This can cause delayed combustion, which starts too late so that a knocking level during the operation of the two-stroke motor 100 can increase.

The two-stroke motor 100 is fitted with an ignition device 26 which is designed so that ignition time for igniting the fuel-air mixture present in the combustion chamber 13 is set at an earlier time before the top dead centre of a piston 21 defining the combustion chamber 13 in terms of stroke movement compared with the ignition time of a two-stroke motor 16 limited to a second chamber 16 (see FIG. 1). The ignition device 26 is schematically shown and is connected to a spark plug 25 of the two-stroke motor 100. In accordance with the invention the ignition device 26 advances the ignition time to before the ignition time which is advantageous when operating a two-stroke motor 100 operated with a conventional single-chamber silence in accordance with FIG. 1.

The ignition time is for example advance by 6° of the crank angle, and if in a two-stroke motor 100 with a conventional silencer 10 in accordance with FIG. 1 the piston 21 at a 24° crank angle before the top dead centre during the upward movement is ignited, in accordance with the invention in a two-stroke motor 100 with a two-chamber silencer according to FIG. 2, the fuel-air mixture is ignited with the piston 21 at a crank angle of 30° before the top dead centre during the upward movement.

The two-stroke motor 100 is for example fitted with a rotation angle sensor 27 designed for determining the rotation angle and/or the speed of the crank shaft 22, whereby the rotation angle sensor 27 is connected to the ignition device 26 and is designed for transmitting rotation angle and/or speed information to the ignition device 26, The rotation angle of the crank shaft 22 before the top dead centre of the piston 21 can be detected and the rotation angle sensor 27 can then, for example, transmit information to the ignition device 26 is the crank angle of the crank shaft 22 shows a value of 30° before the top dead centre of piston 21 during the upward movement.

Also shown is a knocking sensor 28, which is arranged on the cylinder 18 and is connected to the ignition device 26. The knocking sensor 28 is for determining the knocking level during operation of the two-stroke motor 100, and can form a guide parameter for the dynamic change in the ignition time before the top dead centre of the two-stroke motor 100. Of course the knocking sensor 28 can also only be arranged on the cylinder 18 for experimental purposes for configuring a one-off optimum setting of the ignition time before the top dead centre of the piston 21.

A temperature sensor 29 is also shown on the cylinder 18 and the temperature sensor 29 is also connected to the ignition device 26. The temperature sensor 29 is designed for determining the temperature of the cylinder 18, and can be used either for the dynamic regulation of the advancing of the ignition time to a crank angle greater than 24° before the top dead centre of the piston 21, or the temperature sensor 29 is used for one-off optimisation of an advantageous ignition time.

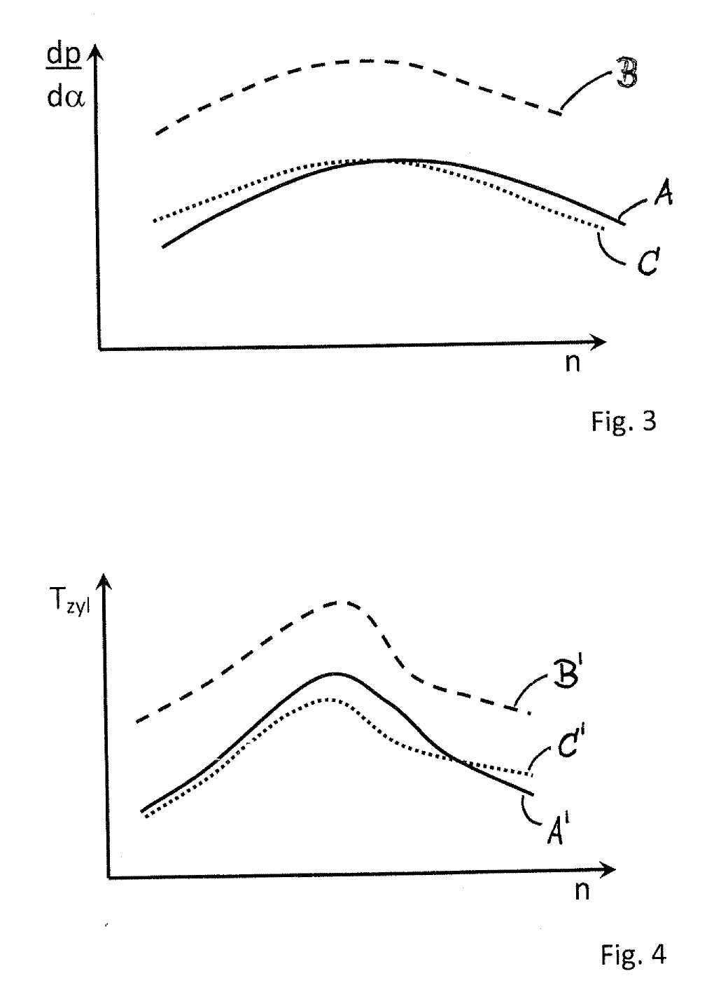

FIG. 3 shows a diagram of the increase in pressure over the crank angle dp/dα over speed n for various operational states of the two-stroke motor 100. The course of the increase in pressure/° crank angle measured over speed n in a two-stroke motor 100 with a single-chamber silencer in accordance with FIG. 1 with an ignition time of 24° is marked A. B shows the course of the increase in pressure/° crank angle during operation of the two-stroke motor 100 with a two-chamber silencer in accordance with FIG. 2 and an ignition time von 24° before the top dead centre, so that the ignition time has not been changed. It can be seen that a greater increase in pressure per ° crank angle sets in, whereby a greater knocking tendency is determined during the operating of the two-stroke motor 100. Curve C finally shows the increase in pressure/° crank angle during the operation of the two-stroke motor 100 with a two-chamber silencer 10 in accordance with FIG. 2, whereby in accordance with the invention the ignition time has been advance and is, for example, already at 30° before the top dead centre, It can be seen that the course of the increase in pressure/° crank angle during operation of the two-stroke motor 100 with the two-chamber silencer and the advanced ignition time approximately corresponds to course A, occurring in a conventional single-chamber silence with an unchanged ignition time of the two-stroke motor 100.

FIG. 4 shows the cylinder temperature T_{cyl} over speed n, whereby course A′ shows the cylinder temperature T_{cyl} during operation of the two-stroke motor 100 with a single-chamber silencer 10 in accordance with FIG. 1 and corresponds with an ignition time of 24° before the top dead centre. Course B′ shows the cylinder temperature T_{cyl} during operation of the two-stroke motor 100 with a two-chamber silencer 10 in accordance with FIG. 2, whereby at 24° before the top dead centre the ignition time has been left in accordance with the operation of the stroke motor 100 with a single-chamber silencer. It can be seen that the cylinder temperature T_{cyl} has increased compared with the cylinder temperature T_{cyl} with a single-chamber silencer. If the temperature is measuring during the operation of the two-stroke motor 100 with a two-chamber silencer 10 and an ignition time advanced to 30° before the top dead centre, this results in a cylinder T_{cyl} in accordance with course C′, which approximately corresponds with course A′, as already determined during the operation of the two-stroke motor 100 with a single-chamber silencer and an ignition time of 24° before the top dead centre.

On the basis of the courses shown in FIGS. 3 and 4 it can be seen that through advancing the ignition time in accordance with the invention the operating parameters during the operation of the two-stroke motor 100 with a two-chamber silencer in accordance with FIG. 2 can also be brought to a level corresponding with the operating parameters during operation of the two-stroke motor 100 with a conventional silencer in accordance with FIG. 1.

The invention is not restricted in its design to the preferable example of embodiment set out above. Rather, a number of variations are conceivable which make use of embodiments essentially different from the illustrated solution. All features and/or advantages, including design details, dimensional arrangements and process stages evident from the claims, the description or the drawings can be essential to the invention both alone and in the most varied of combinations.

### REFERENCE LIST

100 Two-stroke motor
10 Silencer
11 Silencer inlet
12 Flow channel
12′ Channel opening
13 Combustion chamber
14 Channel end
15 First chamber
16 Second chamber
17 Main outlet
18 Cylinder
19 Outlet
20 Secondary outlet
21 Piston
22 Crank shaft
23 Connecting rod
24 Crank housing
25 Spark plug
26 Ignition device
27 Rotation angle sensor
28 Knocking sensor
29 Temperature sensor
dp/dα Increase in pressure/° crank angle
n Speed
T_{cyl} Cylinder temperature
A dp/dα during operation of the two-stroke motor with a single-chamber and ignition time at 24° before the top dead centre measured over speed
B dp/dα during operation of the two-stroke motor with a two-chamber and ignition time at 24° before the top dead centre measured over speed
C dp/dα during operation of the two-stroke motor with a two-chamber and ignition time at 30° before the top dead centre measured over speed
A′ T_{cyl} during operation of the two-stroke motor with a single-chamber and ignition time at 24° before the top dead centre measured over speed
B′ T_{cyl} during operation of the two-stroke motor with a two-chamber and ignition time at 24° before the top dead centre measured over speed
C′ T_{cyl} during operation of the two-stroke motor with a two-chamber and ignition time at 30° before the top dead centre measured over speed

1. Two-stroke motor with a silencer, whereby
the silencer has a silencer inlet to which a flow channel is connected so that
by way of the silencer inlet the flow channel can be attached to an outlet of a combustion chamber of the two-stroke motor,
whereby the flow channel, at the channel end opposite the silencer inlet opens out into a first chamber,
whereby a second chamber is also provided,
into which exhaust gas flows through a main outlet branching off from the flow channel,
whereby the first chamber is optionally surrounded by the second chamber and whereby
the flow channel is designed in flow-beneficial manner between silencer inlet and the first chamber so that due to its mass inertia the exhaust gas flowing into the silencer inlet predominantly flows into the first chamber and after filling the first chamber flows back again and thereby forms a counter-pressure in the direction of the combustion chamber wherein the ignition time for igniting a fuel-air mixture present in the combustion chamber is set at an earlier time before the dead centre of a piston defining the combustion chamber in terms of stroke movement, compared with the ignition time of a two-stroke motor operated with a silencer structurally limited to the second chamber.

2. Two-stroke motor in accordance with claim 1, wherein the ignition time is set earlier before the top dead centre so that knock-free operation of the two-stroke motor sets in or so during operation of the two-stroke motor a knocking level comes about which corresponds with the knocking level of the two-stroke motor with a silencer limited to the second chamber.

3. Two-stroke motor in accordance with claim 1, wherein the ignition time is set earlier before the top dead centre so that during operation of the two-stroke motor a temperature level in the cylinder of the two-stroke motor set in so that the it corresponds to the temperature level during operation of two-stroke motor with a limited to the second chamber.

4. Two-stroke motor in accordance with claim 1, wherein the ignition is set earlier before the top dead centre so that during operation of the two-stroke motor an increase in pressure/° crank angle in the combustion chamber of the cylinder of the two-stroke motor sets in which corresponds with the increase in pressure/° crank angle during operation of the two-stroke motor with a silencer limited to the second chamber.

5. Two-stroke motor in accordance with claim 1, wherein the advancement of the ignition time corresponds to a crank angle of at least 2°.

6. Two-stroke motor in accordance with claim 1, wherein the ignition time is advanced to a crank angle of at least 26° before the top dead centre of the piston.

7. Two-stroke motor in accordance with claim 1, wherein a spark plug is provided for igniting the fuel-air mixture and is operated by an ignition device, whereby the ignition device has means through which the ignition time can be advanced.

8. Two-stroke motor in accordance with claim 7, wherein a rotation angle sensor is provided which is designed for determining the rotation angle and/or the speed of the crank shaft, whereby the rotation angle sensor is connected to the ignition device and is designed for transmitting rotation angle and/or speed information to the ignition device.

9. Two-stroke motor in accordance with claim 8, wherein the rotation angle sensor is integrated into the ignition device so that a crank angle can be determined from the time required per revolution and the time elapsing after passing a trigger threshold.

10. Two-stroke motor in accordance with claim 7, wherein a knocking sensor is provided and connected to the ignition device whereby the knocking sensor designed for determining the knocking level and is optionally arranged on the cylinder.

11. Two-stroke motor in accordance with claim 7, wherein a temperature sensor is provided and connected to the ignition device, whereby the temperature sensor is designed for determining the temperature of the cylinder and is optionally arranged on the cylinder.

12. Power tool with a two-stroke motor in accordance with claim 1.

13. Method of operating a two-stroke motor, whereby the two-stroke motor is designed with a silencer and whereby
the silencer has a silencer inlet to which a flow channel is connected so that
by way of the silencer inlet the flow channel can be attached to an outlet of a combustion chamber of the two-stroke motor,
whereby the flow channel, at the channel end opposite the silencer inlet opens out into a first chamber,
whereby a second chamber is also provided,
into which exhaust gas flows through a main outlet branching off from the flow channel,
whereby the first chamber is optionally surrounded by the second chamber and whereby
the flow channel is designed in a flow-beneficial manner between silencer inlet and the first chamber so that due to its mass inertia the exhaust gas flowing into the silencer inlet predominantly flows into the first chamber and after filling the first chamber flows back again and thereby forms a counter-pressure in the direction of the combustion chamber
wherein the ignition time for igniting a fuel-air mixture present in the combustion chamber is set at an earlier time before the dead centre of a piston defining the combustion chamber in terms of stroke movement, compared with the ignition time of a two-stroke motor operated with a silencer structurally limited to the second chamber.
